(19) United States
(12) Patent Application Publication
(10) Pub. No.: US 2018/0101835 A1
(43) Pub. Date: Apr. 12, 2018

(54) ZONE-BASED MOBILE DEVICE CONFIGURATION FOR HOSPITALITY DEPLOYMENT

(71) Applicant: Agilysys, Inc., Alpharetta, GA (US)

(72) Inventors: Larry Steinberg, Sammamish, WA (US); Alessandro Muti, Mercer Island, WA (US)

(21) Appl. No.: 15/725,809

(22) Filed: Oct. 5, 2017

Related U.S. Application Data
(60) Provisional application No. 62/405,121, filed on Oct. 6, 2016.

(51) Int. Cl. G06Q 20/32; G06Q 50/12; G06Q 30/06

(52) U.S. Cl. CPC G06Q 20/3224; G06Q 30/0639; G06Q 50/12

(57) ABSTRACT

A system and method for the zone-based configuration of a mobile device to be deployed in a hospitality facility. The system maintains a record of zones into which a hospitality facility has been divided, as well as corresponding zone parameters, as provided by a user of the system. A mobile device may be deployed to a zone within the hospitality facility to, for example, take orders from guests in that zone. Prior to deployment, a user of the mobile device selects the zone to which the mobile device is to be deployed, and the mobile device is configured according to the corresponding zone parameters. The services offered through the mobile device, as well as which hotel resources are used to fulfill ordered services and process service payments, are based on the configured zone parameters.

### CROSS-REFERENCE TO RELATED APPLICATIONS(S)

This application claims the benefit of U.S. Provisional Patent Application No. 62/405,121 filed on Oct. 6, 2016, entitled ZONE-BASED MOBILE DEVICE CONFIGURATION FOR HOSPITALITY DEPLOYMENT, which is incorporated herein by reference in its entirety.

### BACKGROUND

Facilities within the hospitality industry offer a variety of different guest services at different facility locations. For example, a hotel may offer food and drink items from one menu to guests on a casino floor at the hotel, food and drink items from a different menu to guests at the hotel pool, and business services at a business center within the hotel. Furthermore, the ordering, processing, and fulfilling of a service may take place at different locations within the facility. For example, a guest at a hotel pool may place an order for food with a waiter assigned to the pool area, the waiter may process the payment for the order at a nearby serving station, and the food may be prepared at a nearby kitchen. Thus, where a service is processed and fulfilled, as well as which services are offered, may depend on where the order for the service is placed.

The handling of the ordering, processing, and fulfilling phases of a service with traditional means, such as a waiter taking an order on a paper slip, can be both inefficient and error-prone. For example, an order recorded on a paper slip may need to be manually entered into a computer or other device at a serving station in order to process a payment for the order, which takes time and risks data-entry error. As a further example, a waiter may mistakenly allow a guest to order an item that is not available at the guest's location. It would therefore be beneficial to facilitate a location-based handling of phases of a service, such as ordering, processing, and fulfillment, within a hospitality facility.

### BRIEF DESCRIPTION OF THE DRAWINGS

FIG. 1 is a diagram of an example environment in which a system for zone-based mobile device configuration may operate.

FIG. 2 is an example graphical user interface for configuring a mobile computing device for deployment to a zone within a hospitality facility.

FIG. 3 is an example resource mapping table for configuring a mobile device for different zones within a hospitality facility.

FIG. 4 is a flow diagram of a process for specifying zone parameters associated with a hospitality facility.

FIG. 5 is a flow diagram of a process for configuring a mobile device for deployment to a zone within a hospitality facility.

FIG. 6 is a flow diagram of a process for utilizing a mobile device configured for deployment to a zone within a hospitality facility.

### DETAILED DESCRIPTION

A system and method for zone-based configuration of a mobile device, to be deployed at a hospitality facility, is disclosed herein. A hospitality facility, such as a hotel, is divided into one or more zones corresponding to different locations within the facility. For example, a hotel may be divided into zones corresponding to a lobby, casino floor, pool, ballroom, and guest room area of the hotel. Zone divisions may be more fine-grained, such as a north casino floor, south casino floor, west casino floor, and east casino floor zone. Each zone is associated with configuration parameters, such as the services and items offered within the zone, the resources associated with the zone, payment rules for the zone, security settings of the zone, and the mobile device interface for that zone. For example, a casino floor zone may be configured to indicate food items from one menu are available within the zone, while a lobby zone may be configured to indicate food items from a different menu are available within the zone. As an additional example, a north casino floor zone may be associated with one resource, such as a credit card reader located in the north casino floor, while a south casino floor zone may be associated with a different resource, such as a cash drawer located in the south casino floor. As a further example, a ballroom zone may be configured with a payment rule such that orders placed within that zone are charged to a group that has reserved the ballroom.

One or more mobile devices may be deployed to each zone, to be used by hospitality staff within that zone. For example, a waiter may use a tablet computer deployed to a pool zone to take orders from guests in the pool area, while a staff member may use a tablet computer deployed to a business center zone to sign up a guest for business center services. Prior to deployment, each mobile device is configured for the zone to which it is to be deployed. As described herein, by configuring a mobile device for the zone to which it is to be deployed, the mobile device offers only the functionalities and options available in that zone, communicates with the resources associated with that zone, and adheres to any rules set for that zone. The mobile device may be configured to a zone manually by a user of the system, automatically based on the location of the mobile device, dynamically based on utilization of other mobile devices within the facility, and other approaches as described herein. An advantage of the zone-based configuration is that it allows for a single mobile device to be used at different locations within a hospitality facility depending on the current configuration of the mobile device. Furthermore, the mobile device may be reconfigured for different zones with ease. This provides a hospitality facility and its staff with the portability to offer services to guests wherever they may be located, and the flexibility to allocate mobile devices as needed.

Though primarily described with reference to a hotel, the system for zone-based configuration of mobile devices may be used in other circumstances in which a mobile device may be deployed in a hospitality or travel setting. For example, the system may be used to configure devices deployed for use at a resort, spa, restaurant, train, flight, cruise ship, or other facilities in which hospitality staff may offer items or services to guests.

Various embodiments of the invention will now be described. The following description provides specific details for a thorough understanding and an enabling description of these embodiments. One skilled in the art will understand, however, that the invention may be practiced without many of these details. Additionally, some well-known structures or features may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### Suitable Environments

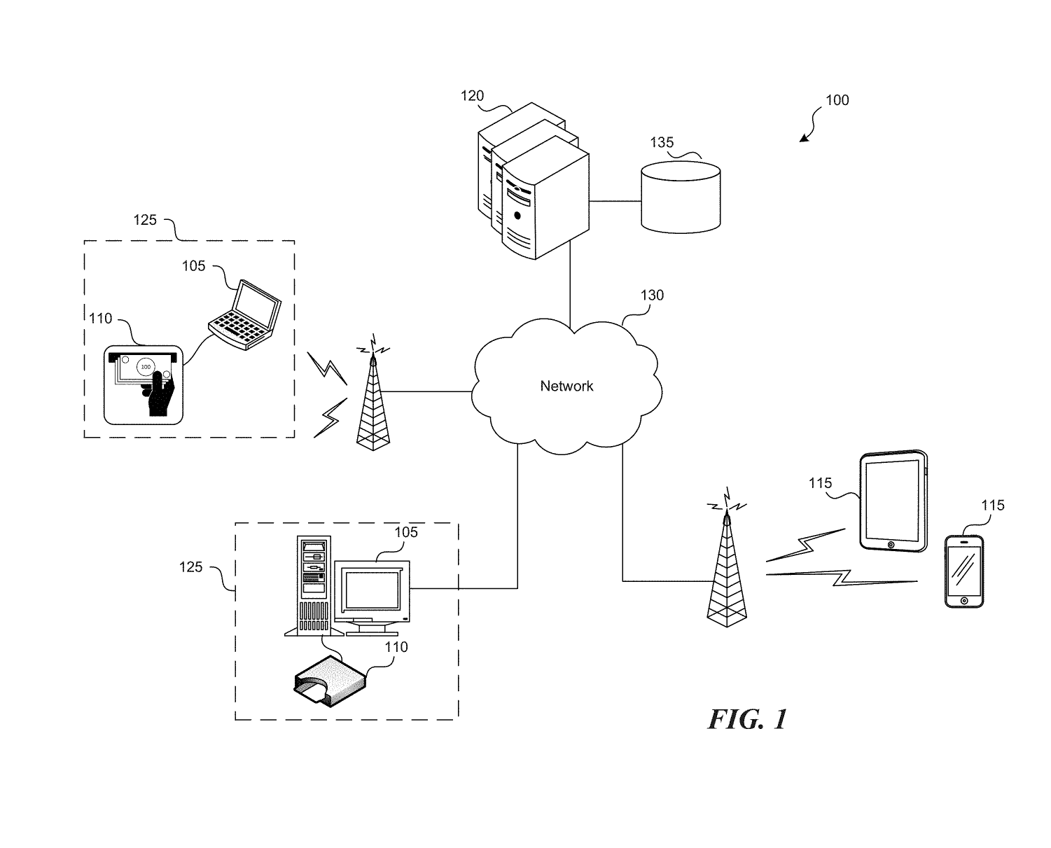

FIG. 1 and the following discussion provide a brief, general description of a suitable environment in which a system to configure mobile devices for deployment to different zones of a hospitality facility may be implemented. Although not required, aspects of the invention are described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein. Indeed, the term “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer.

Referring to the example of FIG. 1, a representative environment 100 in which aspects of the described technology may operate includes one of more service station computing devices 105, hospitality resources 110, mobile computing devices 115, and server computers 120. Service station computing devices 105 and hospitality resources 110 are typically used in combination to provide services to zones 125 of a hospitality facility. For example, a zone 125 corresponding to the pool area of a hospitality facility may be served by one service station computing device 105 (e.g., a computing device for managing pending orders, open tabs, etc.) and hospitality resource 110 (e.g., a credit card reader, cash drawer, magnetic stripe reader, signature capture device, barcode or QR code scanner, RFID scanner, etc.) located within or near the pool area. Additionally, a zone 125 corresponding to the lobby of the hospitality facility may be served by a service station computing device 105 and hospitality resource 110 located within or near the lobby. The mobile computing devices 115 are typically used by employees of the hospitality facility to take orders from or provide other services to guests located within a zone 125. As described herein, those orders or services (such as processing a payment or sending an order to a nearby bar or kitchen) are handled by service station computing devices 105 and hospitality resources 110 based on the configuration of the mobile computing device 115.

The service station computing devices 105, hospitality resources 110, and mobile computing devices 115 communicate with each other and the server computer 120 through networks 130 including, for example, the Internet. The service station computing devices 105, hospitality resources 110, and mobile computing devices 115 may communicate wirelessly with a base station or access point using a wireless mobile telephone standard, such as the Global System for Mobile Communication (GSM), or another wireless standard, such as IEEE 8022.11, and the base station or access point communicates with the server computers 120 via the network 130.

Aspects of the system for configuring mobile devices for deployment to different zones of a hospitality facility may be practiced by service station computing devices 105, hospitality resources 110, mobile computing devices 115, and server computer 115. For example, hospitality zone parameters, associated with a particular hospitality facility and maintained on storage areas 135, may be retrieved by a mobile computing device 115 in use at the hospitality facility. Hospitality zone parameters may then be applied to the mobile computing device 115 based on a zone selection by a user of the mobile computing device. Subsequent orders or service requests entered into the mobile computing device 115 are then handled by service station computing devices 105 and hospitality resources 110 according to the applied zone parameters.

Hospitality zone parameters may be generated by users of the service station computing devices 105, mobile computing devices 115, and other computing devices used for managing a hospitality facility, and are communicated to the server computer 120. That is, a hotel manager or other hotel employee with appropriate access privileges, using a hotel computing device, may define one or more zones (e.g., “lobby,” “pool,” “ballroom,” etc.) for a hotel through a user interface displayed on the hotel computing device. The hotel manager may then specify zone parameters for each of the defined zones.

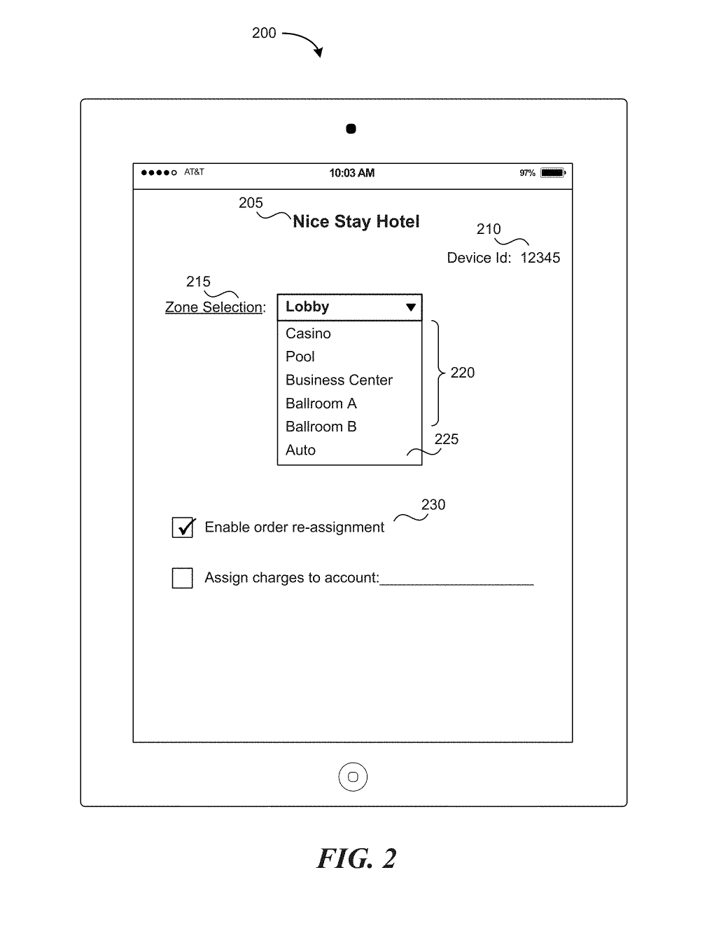

When a mobile computing device 115 is to be deployed to a zone 125 within a hospitality facility (i.e., used by a hospitality facility employee to, for example, take orders from or offer services to guests within the zone), the mobile computing device is first configured for deployment to that zone. Referring to FIG. 2, a graphical user interface 200 may be used by a user to configure a mobile computing device 115 for deployment to a zone 125. The interface includes facility and device information, such as the name of the hospitality facility 205 and a device identifier 210. The interface also includes a zone selection drop-down menu 215, which lists available zones 220 defined for the hospitality facility. As described herein, the selection of a listed zone 220 configures the mobile device for use in the selected zone. A user may also select the auto-selection of zones 225, in which the mobile computing device is automatically configured for the zone in which the mobile computing device is located. The interface also displays options 230 for configuring the mobile computing device, such as whether individual orders may be dynamically reassigned to a nearby zone based on the utilization of the zone to which the mobile computing device is configured, or whether charges accrued within the zone should be charged to a particular account.

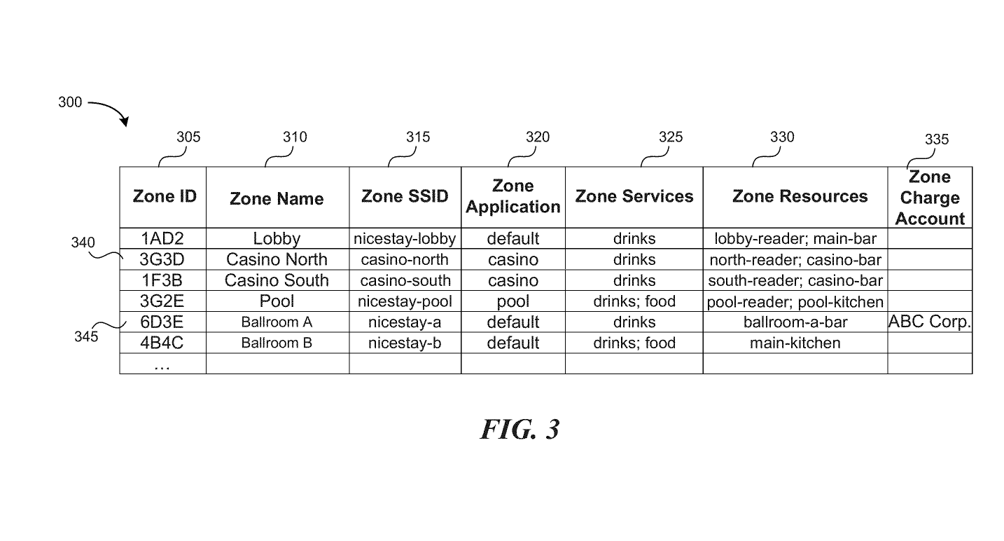

When a zone is selected (either manually by a user through a user interface or automatically based on location), the mobile computing device is configured for that zone according to zone parameters. Referring to FIG. 3, some examples of parameters for different zones in a hospitality facility are illustrated in table 300. Though not illustrated, the table 300 may be associated with a particular hospitality facility corresponding to a facility identifier. The table 300 includes a zone ID field 305 and a zone name field 310 that uniquely identify each zone associated with a hospitality facility and provide a descriptive name for the zone. The table 300 also includes a zone service set identifier (SSID) field 315, indicating the SSID of a wireless access point for the zone. The zone SSID 315 field may be used by the system to determine which zone the mobile computing device is located in, based on the SSID of the wireless access point to which the mobile computing device is connected. The table 300 may store alternative or additional fields to assist in location-determination, such as, for example, coordinates of zone boundaries, the range of IP addresses assigned within each zone, or other information that may be used to detect when a mobile computing device is within a particular zone.

The table 300 includes a zone application field 320 that identifies which application should be run on the mobile computing device when the device is deployed to a particular zone. Mobile computing devices used within a hospitality facility may be preconfigured, prior to deployment, with different mobile applications associated with the facility, and the field may identify the application by name or device location. For example, a default application for entering guest and order information may be used when an employee of the hospitality facility is using the mobile computing device. In a further example, alternative applications designed for guest interaction may be used when the mobile computing device is configured, for example, to be used in self-service operation (e.g., a self-service kiosk, or a mobile computing device loaned to a guest that allows the guest to place orders remotely). When a mobile computing device is configured for a zone, the application corresponding to that zone is launched on the mobile computing device.

The table 300 also includes a zone services field 325 that identifies which services are available in a particular zone. The zone services field 325 may be used by the application, launched based on the zone application field 320, to set which services are offered in a user interface generated by the mobile application. For example, the default ordering application may have the capability to offer both food and drink options (to be selected by a user of the mobile computing device as part of entering an order), but may display only one or neither of the options based on the configuration set by the zone services field. Although FIG. 3 illustrates an example in which the different zone services are “food” and “drink,” other services and ways of characterizing the services within a zone may be used. For example, the zone services field 325 may contain links to different computer-readable menus that may be used by the application to determine which menu items are available within a zone. The zone services field 325 may also contain listings of individual menu items. The zone services field 325 may indicate services unrelated to food and drink, such as printing and other services offered in a business center zone, and massage and treatment services offered in a spa zone. The zone services field may also include day and time ranges for each of the listed services, such that a full menu is available within the zone during daytime hours, and a late-night menu is available within the zone during evening hours.

The table 300 further includes a zone resources field 330 that identifies which hospitality resources are associated with a zone and are used for payment processing, signature capture, order fulfillment, etc. within the zone. Orders entered into a mobile computing device may then be automatically transmitted from the mobile computing device to the hospitality resource for that zone. For example, if an order for food is entered within a zone and the guest wishes to pay by credit card, details of the order may be transmitted to the assigned credit card reader and kitchen. The hospitality facility employee taking the order may then swipe the guest's credit card at the assigned credit card reader without having to re-enter order information (e.g., guest identification, order amounts, etc.), as the needed information has already been transmitted to the credit card reader.

The table 300 additionally includes a zone charge account field 335 that identifies an account to which charges accrued within the zone should be charged. For example, if a business has rented a ballroom for a corporate event, the zone for the ballroom may have the business' account information saved in the zone charge account field 335 and any orders within the zone would be automatically charged to the business. As described above, in addition to using a zone charge account field 335, charge accounts may also be specified during zone configuration of the mobile computing device through a configuration option.

Once the mobile computing device is configured for zone deployment based on the zone parameters, the device may be used by hospitality facility employees or guests for ordering services. For example, a mobile computing device may be configured for deployment to a ballroom (“Ballroom A”) using zone parameters 345. While deployed to the ballroom, the mobile device would launch a default application used for receiving orders, and would only list drink options through the application. The details of any entered drink order would be sent to a bar within the ballroom (“ballroom-a-bar”), where bar staff may then prepare the drink. Furthermore, the price of the drink order would be charged to a charge account associated with the zone (“ABC Corp.”)

### Flows for a Zone-Based Mobile Device Configuration System

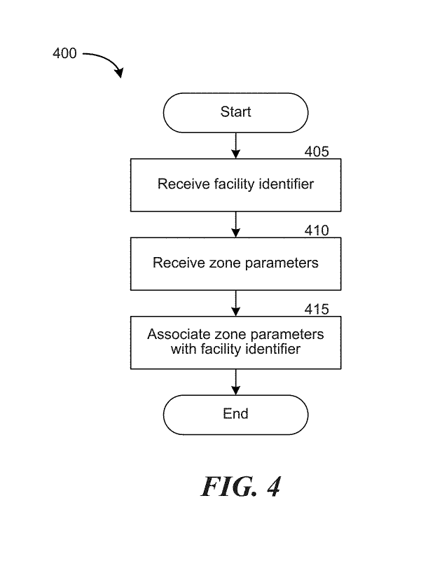

FIG. 4 is a flowchart illustrating an example process 400, implemented by the zone-based configuration system, for associating zone parameters with a hospitality facility. At a block 405, the system receives a facility identifier corresponding to the particular hospitality facility. The facility identifier may be explicitly provided by a user of the system, may be determined based on a login account used by a user to access the system, or may be ascertained by other means.

At a block 410, the system receives a listing of zones to be defined for the hospitality facility, as well as zone parameters for each of the zones. A hotel manager or other employee may provide the zone information, for example, through a user interface generated by the system. For example, the user interface may allow the manager to add and remove the zones to be associated with the hospitality facility. The user interface may further allow the manager to set parameters (such as illustrated in FIG. 3) for each of the zones.

At a block 415, the zone listing and corresponding parameters are associated with the facility identifier. Once associated, the zone listing and parameters are maintained by the system.

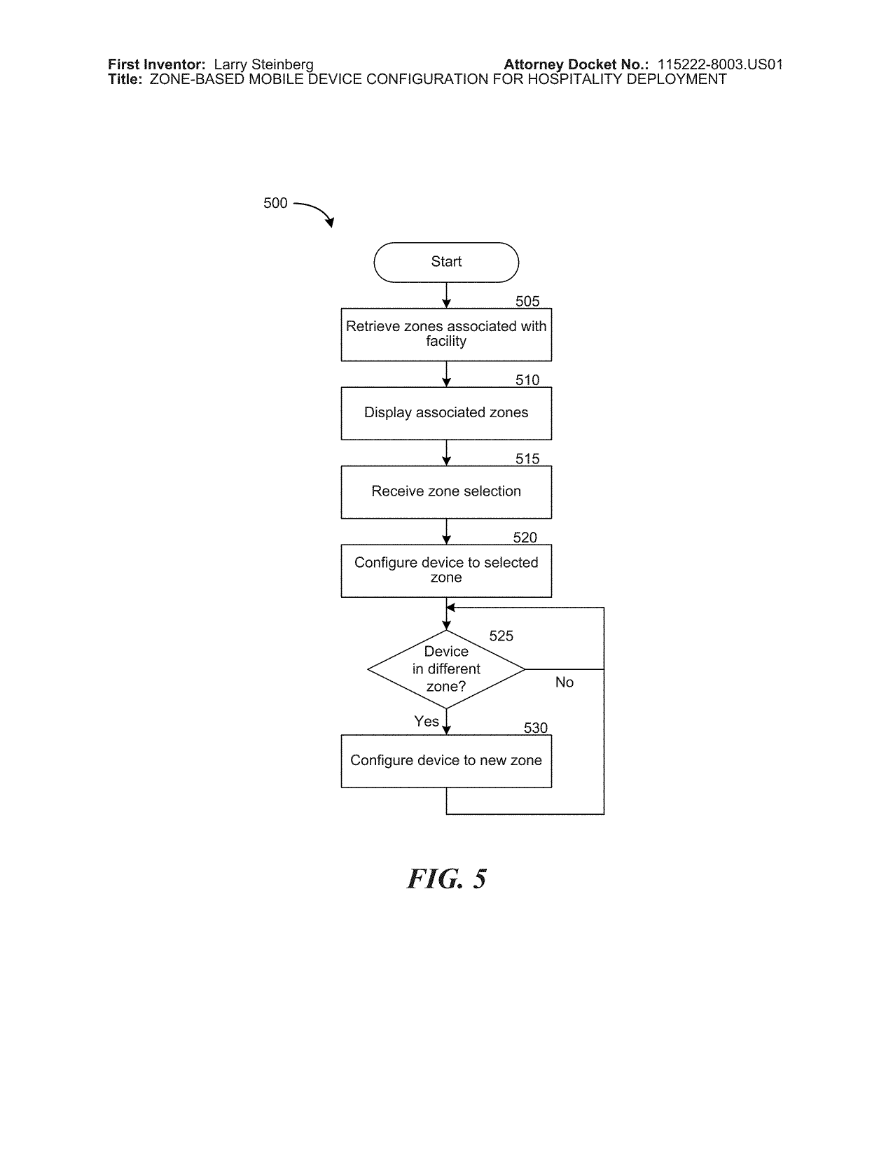

The maintained zone information may then be utilized to configure a mobile device for deployment. FIG. 5 is a flowchart illustrating an example process 500, implemented by the zone-based configuration system, for configuring a mobile device for deployment within a hospitality facility. At a block 505, the system retrieves zone information associated with the hospitality facility. For example, the mobile computing device may be configured with the facility identifier of the hospitality facility, and may provide the identifier as part of a zone retrieval request.

At a block 510, the system displays a listing of zones associated with the hospitality facility. For example, the system may display the associated zones through an interface generated on the mobile computing device being configured, such as the interface illustrated in FIG. 2. At a block 515, the system receives a zone selection. The zone selection may be for a specific zone (e.g., “Ballroom A”) or location-dependent configuration of the mobile computing device (e.g., “Auto”). At a block 520, the mobile computing device is configured based on the retrieved parameters for the selected zone.

At a decision block 525, the system determines whether the mobile computing device is currently in a zone other than the one to which it was configured. For example, as described above with reference to FIG. 3, the coordinates of the mobile computing device, the SSID of the access point to which the device is connected, or the IP address assigned to the device, may indicate that the device is now in a different zone. This may occur, for example, when the mobile computing device is being used by a hospitality facility employee assigned to multiple zones, and the employee moves between zones without manually reconfiguring the mobile computing device. If it is determined that the mobile computing device is in a new zone, then processing continues to a block 530, and the mobile computing device is configured to the parameters for the newly identified zone. If it is determined that the mobile computing device is not in a different zone, then processing returns to the decision block 525 to again determine if the zone location of the mobile computing device has changed.

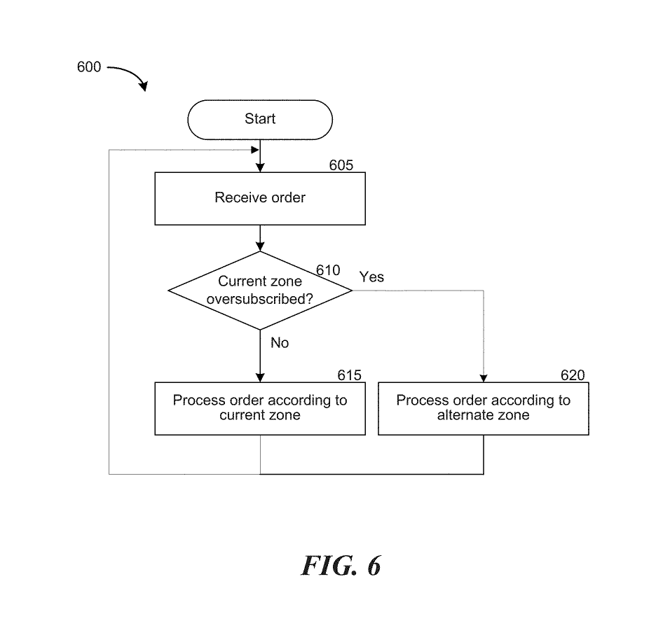

Once a mobile computing device is configured for a zone, it may be used to take orders within that zone. FIG. 6 is a flowchart illustrating an example process 600, implemented by the zone-based configuration system, for processing an order at a deployed mobile computing device. At a block 605, an order is received by the system. For example, an order may be entered into the deployed mobile computing device, by a user (e.g., a hospitality facility employee or guest), through a user interface of the mobile computing device. The order may include item information (i.e., the quantity of items ordered), guest information, payment selection (e.g., pay by cash, pay by provided credit card, charge to guest tab, etc.), and other details.

At a decision block 610, the system determines whether the current zone of the mobile computing device is oversubscribed (i.e., currently handling too many orders within the zone). For example, the system may monitor the rate of orders received within a zone, the number of outstanding orders within the zone, the utilization of different resources (e.g., serving stations, credit card reader, kitchen, bar, etc.) within the zone, the recent wait-time for fulfilling orders within the zone, and other metrics that gauge the utilization of zone resources. When, at the time the order is received, those metrics exceed certain thresholds, then it may be preferable to utilize an alternate zone for processing the order that can fulfill the order in less time. If the current zone is oversubscribed, then processing continues to a block 620. Otherwise processing continues to a block 615.

If at decision block 610 it was determined that the current zone is oversubscribed, then at the block 620 the order is processed by an alternate zone capable of processing the order (i.e., if the necessary resources are available). The alternate zone may be selected dynamically by the system, based on the monitored utilization of nearby zones. The alternate zone may also be preset, such as in the zone parameters of the current zone. After the order is processed, processing returns to the block 605 to await for the next order entered into the mobile computing device.

If at decision block 610 it was determined that the current zone is not oversubscribed, then at the block 615 the order is processed by the current zone to which the mobile computing device is configured. That is, order details are communicated to the hospitality resources associated with the zone. Furthermore, if a charge account is set for the zone (through zone parameters, a configuration-time option, or other), then the order is charged to the charge account. After the order is processed, processing returns to the block 605 to await for the next order entered into the mobile computing device.

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

These and other changes can be made to the disclosed technology in light of the above Detailed Description. While the above description describes certain examples of the disclosed technology, and describes the best mode contemplated, no matter how detailed the above appears in text, the disclosed technology can be practiced in many ways. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

I/we claim:

1. A method for processing an order received at a mobile device deployed to a hospitality facility, the method comprising:
retrieving, at a mobile device, a list of a plurality of zones associated with a hospitality facility from a computing system;
displaying, at the mobile device, the list of the plurality of zones;
receiving, at the mobile device, an indication of a zone selected from the plurality of zones;
configuring the mobile device for the selected zone by:
retrieving zone parameters corresponding to the selected zone, the zone parameters including a list of a plurality of items and a hospitality resource; and
enabling indications of purchase for each of the plurality of items at the mobile device;
receiving, at the mobile device, an indication of purchase for an ordered item, wherein the ordered item is from the plurality of items; and
transmitting the indication of purchase to the hospitality resource.

2. The method of claim 1, wherein the hospitality resource comprises a credit card reader, a cash drawer, a magnetic stripe reader, a signature capture device, a barcode scanner, a QR code scanner, or a RFID scanner.

3. The method of claim 2, further comprising processing a charge associated with the indication of purchase through the hospitality resource.

4. The method of claim 1, wherein the zone parameters further comprises a zone user interface, and wherein configuring the mobile device for the selected zone further comprises displaying the zone user interface on the mobile device.

5. The method of claim 1, wherein the zone parameters further comprises a zone boundary, the method further comprising:
detecting a location of the mobile device;
determining whether the detected mobile device location is within the zone boundary associated with the selected zone; and
configuring the mobile device for an alternate zone based on the determination and the detected mobile device location.

6. The method of claim 1, further comprising:
receiving, at the computing device, an account identifier; and
applying, to the identified account, a charge associated with the indication of purchase.

7. The method of claim 1, wherein the hospitality facility is a hotel.

8. A non-transitory computer-readable medium encoded with instructions that, when executed by a processor, perform a method for processing an order received at a mobile device deployed to a hospitality facility, the method comprising:
retrieving, at a mobile device, a list of a plurality of zones associated with a hospitality facility from a computing system;
displaying, at the mobile device, the list of the plurality of zones;
receiving, at the mobile device, an indication of a zone selected from the plurality of zones;
configuring the mobile device for the selected zone by:
retrieving zone parameters corresponding to the selected zone, the zone parameters including a list of a plurality of items and a hospitality resource; and
enabling indications of purchase for each of the plurality of items at the mobile device;
receiving, at the mobile device, an indication of purchase for an ordered item, wherein the ordered item is from the plurality of items; and
transmitting the indication of purchase to the hospitality resource.

9. The non-transitory computer-readable storage medium of claim 8, wherein the hospitality resource comprises a credit card reader, a cash drawer, a magnetic stripe reader, a signature capture device, a barcode scanner, a QR code scanner, or a RFID scanner.

10. The non-transitory computer-readable storage medium of claim 9, further comprising processing a charge associated with the indication of purchase through the hospitality resource.

11. The non-transitory computer-readable storage medium of claim 8, wherein the zone parameters further comprises a zone user interface, and wherein configuring the mobile device for the selected zone further comprises displaying the zone user interface on the mobile device.

12. The non-transitory computer-readable storage medium of claim 8, wherein the zone parameters further comprises a zone boundary, the method further comprising:
detecting a location of the mobile device;
determining whether the detected mobile device location is within the zone boundary associated with the selected zone; and
configuring the mobile device for an alternate zone based on the determination and the detected mobile device location.

13. The non-transitory computer-readable storage medium of claim 8, further comprising:
receiving, at the computing device, an account identifier; and
applying, to the identified account, a charge associated with the indication of purchase.

14. The non-transitory computer-readable storage medium of claim 8, wherein the hospitality facility is a hotel.
